(19) United States
(12) Patent Application Publication
(10) Pub. No.: US 2011/0221213 A1
(43) Pub. Date: Sep. 15, 2011

(54) MOTOR VEHICLE FRONT FACE WITH A RIGID BEAM INSERTED BETWEEN THE IMPACT ABSORBERS AND THE MAIN LONGITUDINAL MEMBERS

(75) Inventors: Caroline Riviere, Faverolles (FR); Claude Laurent, Voujeaucourt (FR); Patrick Borde, Montbeliard (FR)

(73) Assignee: FAURECIA BLOC AVANT, Nanterre (FR)

(21) Appl. No.: 12/671,756

(22) PCT Filed: Jul. 30, 2008
(86) PCT No.: PCT/FR2008/051434

§ 371 Date: Mar. 31, 2010

(30) Foreign Application Priority Data
Aug. 3, 2007 (FR) 07 56934

(51) Int. Cl. B60R 19/26

(52) U.S. Cl. 293/132

(57) ABSTRACT

According to the invention, the front face (1) of the vehicle can be rigidly attached to the front ends (2) of the two main rails (4) of the automobile. The front face includes (1): two shock absorbers (26) provided as an extension of the respective front ends (2) of the main rails (4), each absorber (26) being adapted for absorbing the so-called “medium-speed” shocks; and a rigid transverse beam (10). The beam (10) is rigidly attached by opposite transverse end portions (37) to the front ends (2) of the two main rails (4), said end portions (37) being provided between the shock absorbers (26) and the front ends (2) of the main rails (4).

The present invention relates in general to motor vehicle front faces.

More precisely, the invention relates to a front face that can be fixed rigidly to the front ends of the two main longitudinal members of the motor vehicle, the front face being of the type comprising:
two impact absorbers arranged in the extension of the front ends of the main longitudinal members, each absorber being suitable for absorbing so-called medium-speed impacts,
a rigid transverse beam.

FR-A-2 871 122 describes a bumper beam mounted on the main longitudinal members of the vehicle by means of medium-speed impact absorbers. The beam stabilises the main longitudinal members. This beam therefore comprises a U-shaped rigid metal insert which is open at the top and made of a plastics material moulded onto the insert. This beam occupies a considerable volume at the front of the vehicle and limits the front face designers' margin of manoeuvre to arrange the components providing the other functions of the front face, for example the radiator support components, the headlight supports, the supports for the pedestrian impact absorption components, etc.

In this context, the object of the invention is to provide a front face that gives greater freedom in the design of the front face zone situated in front of the longitudinal members.

The invention therefore relates to a front face of the aforementioned type, characterised in that the beam is fixed rigidly by opposite transverse end portions to the front ends of the two main longitudinal members, said end portions being inserted between the impact absorbers and the front ends of the main longitudinal members.

The front face may also have one or more of the characteristics below, taken individually or in any technically possible combination:
the beam is a metal plate;
the metal plate comprises a substantially flat central zone, said central zone extending in a substantially vertical and transverse plane;
the central zone extends over most of the transverse length of the beam and over most of the vertical height of the beam;
the metal plate comprises a raised edge directed towards the rear of the vehicle relative to the central zone, said raised edge extending over most of the periphery of the central zone;
the metal plate comprises a raised edge directed towards the front of the vehicle relative to the central zone, said raised edge extending over most of the periphery of the central zone;
the metal plate is pressed;
the beam is a metal tube;
the tube is extruded;
the tube is delimited by a transverse peripheral wall in which two slots are provided, the medium-speed impact absorbers engaging inside the beam through the slots;
the front face comprises at least one transverse cross member and at least one fastening lock for the motor vehicle bonnet, the or each lock being fixed rigidly to the cross member, the cross member being situated substantially vertically in the region of the front ends of the main longitudinal members;
the medium-speed impact absorbers are inserted between the opposite transverse end portions of the cross member and the end portions of the beam;
the medium-speed impact absorbers each comprise a block made of a cellular material and a casing into which the block is inserted, the end portions of the cross member forming the casings of the medium-speed impact absorbers;
the cross member is a component made of an integrally moulded plastics material; and
the cross member has an opening towards the rear of the vehicle closed by the beam.

Other characteristics and advantages of the invention will become clear from the detailed description given below as a non-limiting indication with reference to the accompanying drawings, in which:

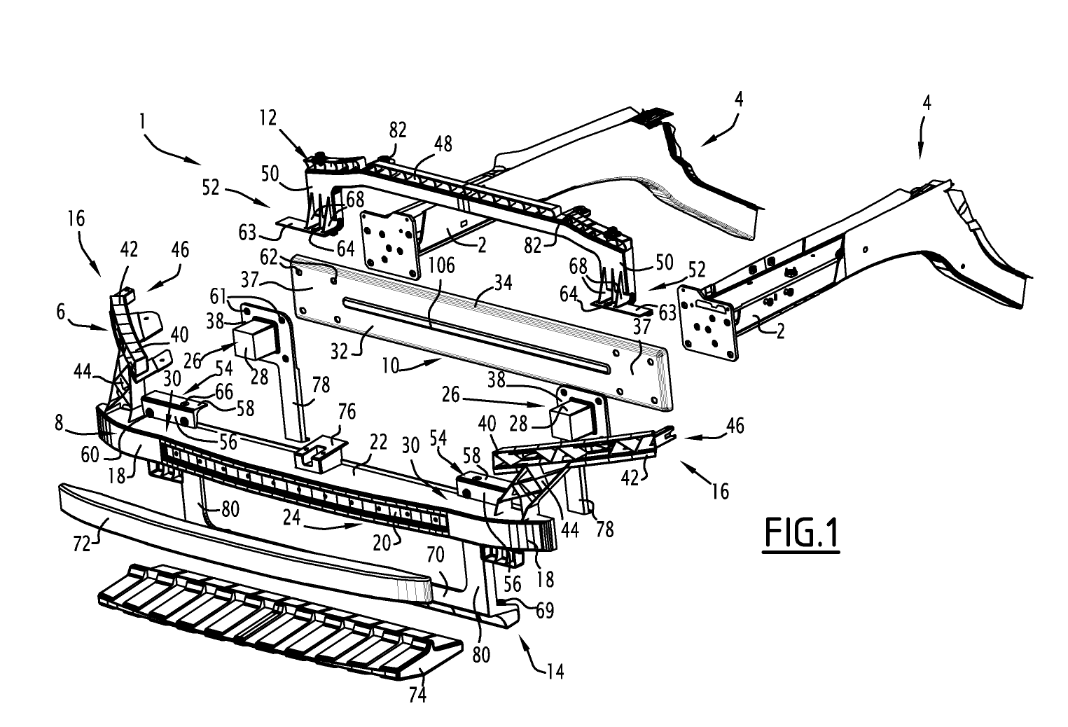

FIG. 1 is an exploded perspective view of a front face according to the invention;

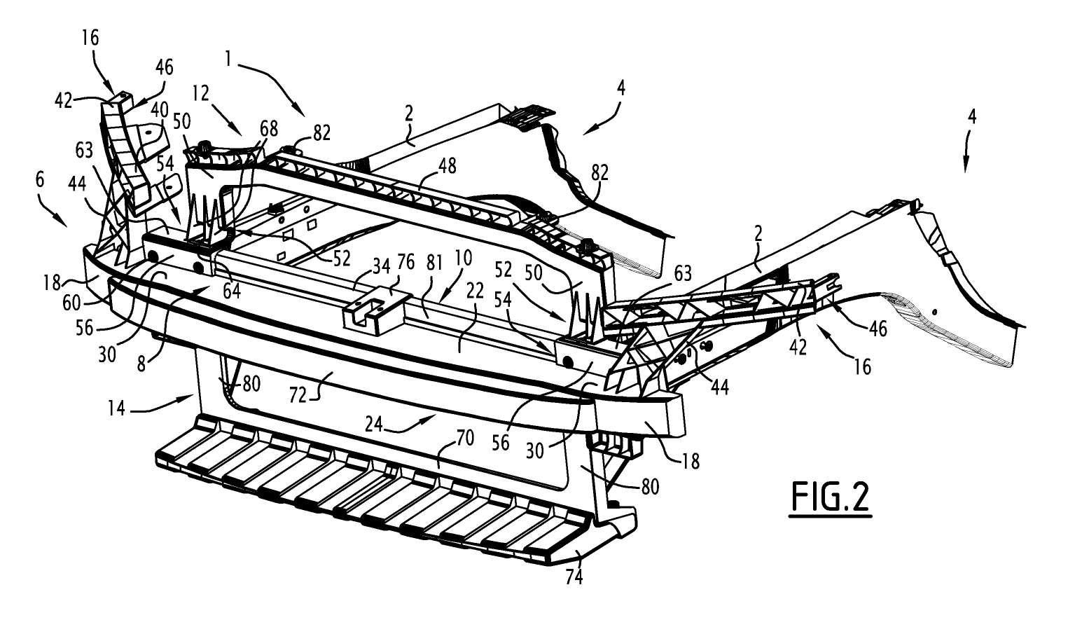

FIG. 2 is a perspective view of the front face of FIG. 1 in the assembled state;

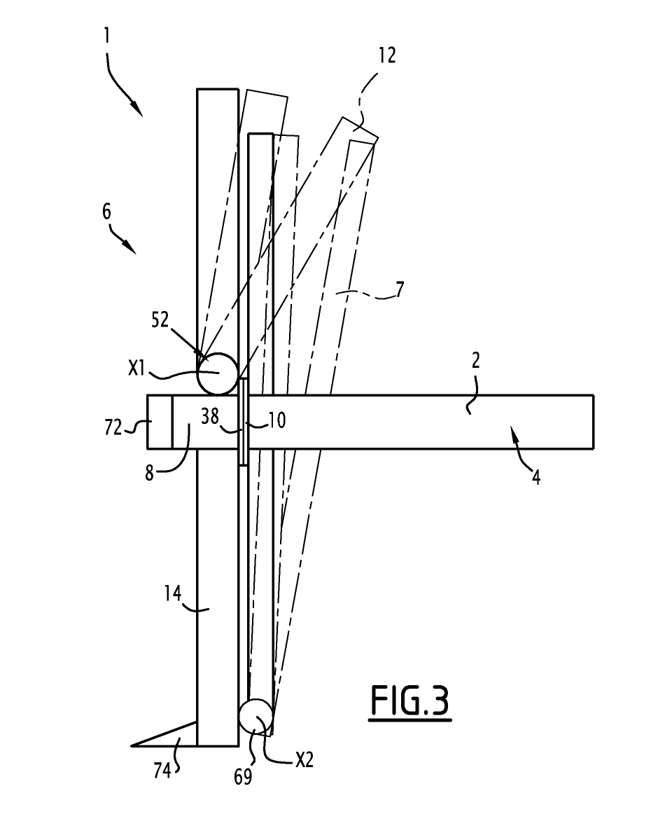

FIG. 3 is a simplified diagrammatic illustration, in a side view, of some of the components of the front face of FIGS. 1 and 2, illustrating the behaviour of the upper cassette half and the radiator in a hip-type pedestrian collision;

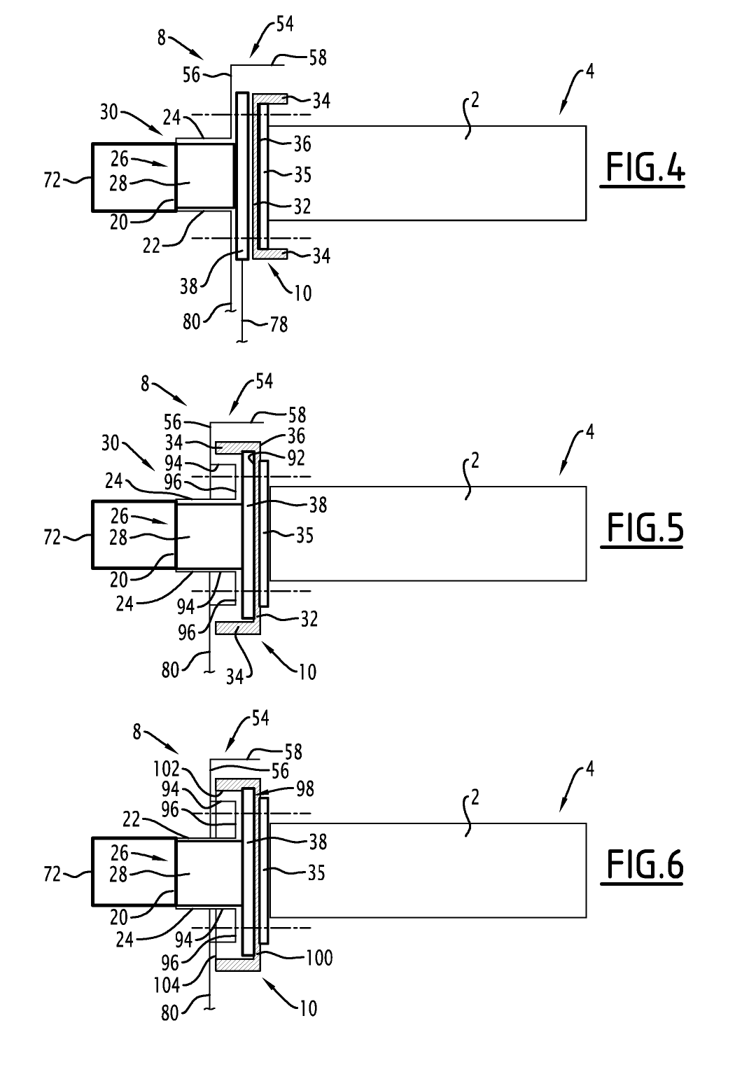

FIG. 4 is a simplified diagrammatic illustration, in a side view, of some of the components of the front face of FIGS. 1 and 2;

FIG. 5 is a view similar to that of FIG. 4 for a variant of the invention; and

FIG. 6 is a view similar to that of FIGS. 4 and 5 for a further variant of the invention.

In the description that follows, the front, rear, longitudinal and transverse directions should be understood relative to the normal direction of movement of the vehicle.

The front face 1 shown in FIG. 1 is an assembly for mounting in one piece on the front ends 2 of the main longitudinal members 4 of the motor vehicle. The front ends of the main longitudinal members are situated in a vertical plane halfway up the front of the vehicle, it being possible for said vehicle to also comprise upper longitudinal members (not shown) situated above the main longitudinal members for stiffening the vehicle wings, and lower longitudinal members (not shown) situated beneath the main longitudinal members so as to support a pedestrian impact absorber, for example.

The front face 1 comprises a rigid support structure 6, and a plurality of accessories fixed rigidly to this structure. Included among these accessories are in particular the radiator 7 of the engine cooling circuit (see FIG. 3), an electric fan assembly suitable for creating forced air convection on contact with the radiator, the front headlights, the front direction indicators, the horn, one or more parking sensors, fog lights, components of the ventilation and air conditioning circuit for the vehicle interior, control sensors for the different airbags of the vehicle and impact absorbers.

All these components are usually mounted on the rigid structure of the front face in the workshop of the front face supplier and said front face, with the pre-mounted accessories, is then mounted on the main longitudinal members of the vehicle at the assembly plant of the motor vehicle constructor.

The rigid structure 6 comprises a transverse cross member 8, a rigid transverse beam 10, an upper cassette half 12 to immobilise the radiator 7, a lower cassette half 14 to support the radiator 7 and two arms 16 to support the headlight housings.

The cross member 8 is an integrally moulded component made of a plastics material. It extends transversally substantially over the entire width of the vehicle. In the vertical direction, it is situated substantially level with the front ends 2 of the main longitudinal members. It therefore has opposite end portions 18 arranged longitudinally in the extension of the front ends 2 of the main longitudinal members.

Considered in a plane perpendicular to the transverse direction the cross member 8 is of a U-shaped section, open at the rear. Towards the front of the vehicle it has a closed frontal face 20. At the top and bottom it is delimited by upper 22 and lower 24 closed faces. It is reinforced by integrally moulded struts, for example, arranged in the internal space of the U-shaped cross member, which interconnect the three faces 20, 22, 24 of the cross member.

The front face 1 also comprises different absorbers provided to absorb impacts between the vehicle on which said front face is fitted and another vehicle. The front face comprises in particular absorbers provided to absorb medium-speed impacts on another vehicle, that is, at a relative speed of about 16 km/h. These are known as repairability impacts. In a collision, each absorber can absorb energy of between 4000 J and 18000 J (Allianz impact). The absorbers 26 can be seen in FIG. 1. Absorbers of this type typically comprise a block made of a cellular material 28 and a casing 30 in which the block 28 engages. The block 28 is preferably made of a metallic or composite cellular material. It is made of aluminium foam for example, or has a honeycomb structure made of aluminium or an aluminium alloy. To obtain good absorber behaviour in a collision, these blocks must be arranged in a casing delimiting a housing formed substantially complementary to the block. The deformation of the casing under the effect of the collision makes it possible to control the behaviour of the block. Since the function of the block 28 is not to support the beam 10 it works optimally.

As shown in FIG. 1, each casing 30 consists of an end portion 18 of the cross member. These end portions each comprise a plurality of walls defining the reception housing of a block 28.

It can also be seen in FIG. 1 that the blocks 28 are inserted longitudinally between the front ends 2 of the longitudinal members and the end portions 18 of the cross member.

The beam 10 has the function of a bumper beam. It therefore constitutes the structural component of the motor vehicle bumper. Its function in a high-speed collision is also to stabilise the front portions 2 of the main longitudinal members of the vehicle. In a high-speed collision, the beam braces the upper longitudinal members.

In a first embodiment of the invention, shown in FIGS. 1 to 3, the beam 10 is a transversely elongate rectangular metal plate. It comprises a substantially flat central zone 32, extending in a substantially vertical and transverse plane. The plate 10 also comprises a raised edge 34 directed towards the rear of the vehicle relative to the central zone 32. The central zone 32 extends over almost the entire transverse length and vertical height of the beam 10. It therefore has a rectangular form corresponding substantially to the rectangular form of the beam.

The raised edge 34 extends continuously over the entire periphery of the central zone 32. It therefore comprises two large transverse portions and two small vertical portions.

As shown in FIG. 4, the front ends 2 of the main longitudinal members carry mounting plates 35 for fixing to the beam 10. The mounting plates 35 are oriented transversely and vertically and are welded, for example, to the tip of each end 2. The mounting plates 35 are mutually unconnected and independent of one another. Each mounting plate 35 is applied to the face 36 of the central zone of the beam facing towards the rear. The raised edges 34 of the beam project towards the rear relative to the mounting plate 35, above and beneath said mounting plate.

The beam 10 is fixed rigidly to the mounting plates 35 of the longitudinal members by two opposite transverse ends 37. It is fixed to the mounting plates by any suitable means, such as welding points or bolts as described below. The ends 37 of the beam 10 are inserted longitudinally between the impact absorbers 26 and the mounting plates of the main longitudinal members.

The impact absorbers 26 each comprise a mounting plate 38 for fixing the impact absorber to the beam 10. The mounting plate 38 is fixed rigidly to the block 28 by welding, for example, or is integral with said block. The mounting plate 38 is fixed to the corresponding end 37 of the beam by means of fixing bolts, as described below.

The arms 16 for supporting the headlight housings are of the type described in patent application EP-1 232 932. They are situated, in the vertical direction, at a distance above the cross member 8. Typically, they are integrally moulded with the cross member 8.

As shown in FIG. 1, the arms 16 are elongate in shape and extend from an inner end 40 towards the rear and towards the outside of the vehicle to an outer end 42. Each arm 16 is connected to the cross member 8 by means of a leg 44 which is also integral with the cross member 8.

The front face also comprises means 46 for connecting the outer end 42 of the arm 16 to one of the upper stiffening longitudinal members of the vehicle wings. The means 46 typically comprise indexing means of the arm 16 relative to the vehicle wing and positive fixing means of said arm to the corresponding upper longitudinal member. The indexing means may comprise a pin, for example. The positive fixing means may comprise one or more bolts, for example.

The means 46 rigidly attach the arm 16 to said upper longitudinal member.

The upper cassette half 12 is positioned above the cross member 8. It is generally in the shape of a bow which is open downwards, that is, towards the cross member 8. It is integrally moulded using a plastics material. It comprises a central transverse portion 48 and two legs 50 extending perpendicular to the central portion 48 from the two opposite ends thereof. The legs 50 are fixed rigidly to the cross member 8 by frangible fixing means 52.

The cross member 8 has angles 54 on its two end portions 18. Each angle 54 has a substantially vertical and transverse flange 56 integral with the cross member 8, and a substantially horizontal flange 58 extending towards the rear from the vertical flange 56. The angles 54 are integrally moulded with the cross member 8. The vertical flange 56 has two orifices 60. The orifices 60 are placed facing corresponding orifices 61 and 62 provided in the mounting plate 38 and in the end 37 of the beam corresponding to the angle 54 respectively. Bolts, represented by dotted and dashed lines in FIG. 4, engage through the orifices 60, 61, 62 placed so as to correspond, in such a way that the beam 10, the mounting plate 38 and the end 37 of the cross member are pressed together and interlock.

It should be noted that the mounting plate 35 for the main longitudinal members may have orifices positioned to coincide with the orifices 62 of the beam. In this case, said fixing bolts may engage in these orifices enabling the cross member 8, the impact absorbers 26 of the beam 10 and the mounting plates 35 to be fitted together.

The frangible fixing means 52 comprise sole plates 63 integral with the free ends of the legs 50 and applied above the horizontal flanges 58 of the angles. The sole plates 63 and the flanges 58 have orifices 64 and 66 arranged so as to correspond. Bolts (not shown) for fixing the upper cassette half to the cross member engage in the orifices 64 and 66. The legs 50 extend substantially perpendicular to the sole plates 63. The legs 50 are connected to the sole plates 63 by a plurality of fins 68 made of a plastics material. Recesses (not shown) are provided in the sole plate 63 at the base of the fins 68. The sole plates 63, the fins 68 and the recesses form the frangible fixing means 52. As detailed below, the means 52 make it possible for the upper cassette half to be retractable in a hip-type pedestrian collision, in accordance with the principles of applications FR 06 04571 and FR 06 04577 filed by the applicant.

The lower cassette half 14 is arranged beneath the cross member 8. It is in a bow shape similar to that of to the upper cassette half. The bow is open at the top, that is, towards the cross member 8. The lower cassette half has no direct connection with the upper cassette half. The lower cassette half 14 is typically integrally moulded with the cross member 8. The connection means between the lower cassette half 14 and the cross member 8 are not frangible in a pedestrian collision. The lower cassette half 14 comprises two eyelets 69 to support and immobilise the lower portion of the radiator. The eyelets 69 project towards the rear of the vehicle relative to the central transverse portion 70 of the lower cassette half.

The front face 1 comprises an absorber 72 suitable for absorbing leg-type pedestrian collisions. The absorber 72 is a plastics material foam bar fixed rigidly to the frontal face 20 of the cross member 8 or may be injected or formed in a single piece with the cross member 8. The absorber 72 extends over most of the transverse length of the cross member 8, substantially from one main longitudinal member to the other.

The front face comprises another absorber 74, provided to absorb leg-type pedestrian collisions, fixed rigidly to the central portion 70 of the lower cassette half. This so-called low channel absorber has the form of a substantially horizontal tray made of a plastics material foam. It extends towards the front from the central portion 70 of the lower cassette half.

The front face also comprises a lock 76 for fastening the bonnet of the motor vehicle. This lock 76 is fixed rigidly to the upper face 22 of the cross member, transversely substantially halfway between the two longitudinal members 4, in other words in the centre of the cross member 8.

Each of the mounting plates 38 for fixing the absorbers to the beam 10 comprises an extension 78 of appropriate cross-section serving as a stiffener for a vertical leg 80 of the lower cassette half. The stiffeners 78 extend downwards from the mounting plate 38 and are integral therewith. They are laid flat against the legs 80, at the rear thereof.

In the assembled state of the front face, shown in FIG. 2, the blocks made of cellular material 28 engage inside the cross member 8, the mounting plate 38 resting against the vertical flanges 56 of the angles. The mounting plate 38 is sandwiched between the flange 56 and the end 37 of the beam. Towards the front, the beam 10 is applied to the open rear face of the cross member 8 and closes said rear face. Towards the rear, the beam is applied to the mounting plates 15 of the longitudinal members by its ends 37. The lower 14 and upper 12 cassette halfs are arranged substantially in the same transverse and vertical plane, above and beneath the cross member 8.

As shown in FIG. 2, the upper transverse edge 81 of the beam projects above the upper face 22 of the cross member. The lock 76 rests on said edge 81.

The radiator 7 rests on the eyelets 69 of the lower cassette half. It comprises spigots projecting downwards, these spigots engaging in the eyelets 69. The spigots cooperate with the eyelets 69 to immobilise the lower portion of the radiator in translation in a horizontal plane.

In addition, the upper cassette half comprises traversing orifices 82 with vertical axes. Pins engage through the orifices 82. Their ends engage in reception housings provided on the upper portion of the radiator. The pins are locked in position relative to the upper cassette half by removable keys. The means for immobilising the radiator relative to the upper and lower cassette halfs are known per se and will not be described in more detail here.

By their lower portion, the headlight housings rest on the arms 16 and are fixed rigidly to these arms 16. Moreover, the front face comprises means, which are not shown, for fixing the upper portions of the headlight housings to the vehicle wings.

In a pedestrian collision, the hip or head of the pedestrian may hit the vehicle bonnet substantially in the region of the upper cassette half 12. If the energy transmitted by the impact to the upper cassette half exceeds a predetermined limit, the connection means 52 break and the cassette half 12 tilts rearwards and downwards about a transverse axis X1 passing substantially through the sole plates 63. As shown in FIG. 4, the tilting of the upper cassette half causes the radiator 7 to tilt about a transverse axis X2 passing substantially through the eyelets 69. For its part, the lower cassette half does not move. The pivoting of the radiator relative to the lower cassette half is made possible by the fact that the lower portion of the radiator is immobilised simply by the spigots of the radiator engaging in the eyelets 69 of the lower cassette half. Similarly, a relative pivoting of the radiator 7 in relation to the upper cassette half 12 occurs, which is made possible by the fact that the upper cassette half is connected to the radiator by pins which simply engage in housings provided on the radiator.

In a variant shown in FIG. 5, the peripheral edge 34 of the beam 10 is raised and directed towards the front of the vehicle relative to the central zone 32. The mounting plate 35 is, as in FIG. 3, fixed rigidly to the face 36 of the central zone 32 facing towards the rear. On the other hand, the mounting plate 38 of each impact absorber is applied to the face 92 of the central zone facing towards the front. The raised edge 34 projects forwards relative to the mounting plate 38, above and beneath said mounting plate. The angles 54 of the cross member and the arms 80 of the lower cassette half are offset towards the front of the vehicle relative to the variant in FIG. 4, so as to accommodate the raised edge 34. The vertical flange 56 of the angle and the arm 80 each comprise a compartment 94 of which the base 96 is applied to the mounting plate 38 of the impact absorber. The orifices 60 through which the fixing bolts pass are provided on the bases 96. The fixing bolts are symbolised in FIG. 5 by a dotted and dashed line. They positively connect the beam 10, the impact absorbers, the cross member 8 and possibly the mounting plates 35 to one another.

In another variant shown in FIG. 6, the beam 10 is a metal tube, made typically of aluminium. The tube is manufactured by extrusion, for example. In this case, the beam 10 is hollow, of rectangular cross-section in a plane perpendicular to the transverse direction. The tube 10 is delimited by a peripheral wall 98. The mounting plates 35 of the longitudinal members are fixed rigidly to the fin 100 of the peripheral wall 98 facing towards the rear. Moreover, the beam 10 comprises two slots 102 provided in the fin 104 of the peripheral wall facing towards the front. Said slots are provided in the extension of the front ends 2 of the longitudinal members, in other words level with the mounting plates 35.

The impact absorbers 26 engage inside the beam 10 through the slots 102. The mounting plate 38 of each medium-speed impact absorber is applied to the fin 100, on a side of said fin 100 facing towards the interior of the beam. The block made of cellular material 28 engages in part inside the beam 10 and projects forwards outside the beam 10 through the slot 102. The projecting portion of the block 28 engages inside the cross member 8.

As previously, the angles 54 and the arms 80 are offset towards the front compared with the variant in FIG. 4. As in the variant in FIG. 5, each flange 56 and each arm 80 comprises a compartment 94 of which the base 96 has orifices 60 through which the fixing bolts 106 pass. These bolts positively connect the cross member 8, the impact absorbers 26, the beam 10 and possibly the mounting plate 35 to one another.

The front face described above has many advantages.

Since the beam is fixed rigidly by opposite transverse end portions to the front ends of the main longitudinal members, said end portions being inserted between the impact absorbers and the front ends of the main longitudinal members, the components of the front face situated in front of the impact absorbers no longer have the function of stabilising the main longitudinal members of the vehicle or of stiffening the bumper. The form and arrangement of these components may therefore be chosen freely depending on other constraints linked to other functions of the front face, for example to support the radiator, support the headlights, support the pedestrian impact absorption components, etc.

The beam may be produced easily in the form of a pressed metal plate.

The central zone of the plate makes it possible to fix the longitudinal members and the impact absorbers, the raised edge giving the beam greater rigidity.

Since the central zone extends in a transverse and vertical plane, the size of the beam in the longitudinal direction is extremely low.

The raised edge of the beam may be directed forwards or rearwards, depending on requirements.

Since the beam is arranged between the main longitudinal members and the medium-speed impact absorbers, space can be freed in front of the impact absorbers in which to arrange a transverse cross member made of a plastics material which supports the vehicle bonnet lock. In front faces known in the art, this cross member extends at a distance above the main longitudinal members of the vehicle. Its position impedes access to the vehicle headlights, in particular to change the bulbs of said headlights, and forms a hard place in a pedestrian collision involving the hips or head. When, as in the invention, it is positioned vertically at the same level as the beam and the main longitudinal members, the cross member does not have the above drawbacks.

The cross member does not reduce the air flow for cooling the radiator, as it is incorporated into the impact absorption zone occupied in the known art by the bumper beam.

The upper cassette half is not a structural component, since neither the stability between the main longitudinal members themselves nor that between the upper longitudinal members and the main longitudinal members is provided by said upper cassette half. The upper cassette half may therefore be made of a less rigid material which is more suitable with regard to the requirements for absorbing pedestrian impacts involving the hips and head.

The front face elements, which vary from one vehicle to another within the same constructor range, are brought together on the cross member. These elements are basically the position of the headlight supports, the location of the lock and the location of the connection points to the upper longitudinal members of the wing.

The longitudinal position of the beam makes it possible to increase the value of the vehicle body deformation modes.

The front face may have many variants.

If the beam is a metal plate, said plate may be non-rectangular in form. It may in particular not be delimited by straight edges. The raised edges may not extend over the entire periphery of the central zone, but only over a portion of said periphery, usually over most of the periphery, in other words over more than half of said periphery.

To increase the rigidity of the beam, the plate may comprise hollow or projecting reliefs in the central zone, such as the transverse rib 106 shown in FIG. 1.

The plate may be obtained not by pressing, but by any other suitable means.

If the beam is a metal tube, the tube is not necessarily of rectangular cross-section but may be of round, oval or any other suitable cross-section.

The tube may be made of a material other than aluminium, for example magnesium or a magnesium alloy, steel, or any other suitable material.

The tube may be obtained by a method other than extrusion.

In a non-preferred variant, the cross member 8 may not be arranged vertically at the same level as the beam 10, but be arranged level with the upper longitudinal stiffening members of the vehicle wings.

The cross member 8 may not be an integrally moulded component made of a plastics material, but comprise a metal insert and a plastics material moulded over the insert.

The portion of the cross member forming a reception casing of the block made of cellular material for the medium-speed impact absorbers may be reinforced by a metal insert.

The support arms of the headlight housings may not be integral with the cross member but be components attached to the cross member 8.

The lower cassette half 14 may not be integral with the cross member 8, but, like the upper cassette half, be attached to the cross member.

The integral impact absorber of the lower cassette half may be integrally moulded with said lower cassette half. This absorber may also serve to absorb so-called compatibility impacts between vehicles.

The front face may comprise not one, but two or more locks for fastening the bonnet, the locks being distributed along the cross member and all being integral with the cross member.

1. Motor vehicle front face (1), the front face (1) being capable of being fixed rigidly to front ends (2) of the two main longitudinal members (4) of the motor vehicle, the front face (1) comprising:
two impact absorbers (26) arranged in the extension of respective front ends (2) of the main longitudinal members (4), each absorber (26) being suitable for absorbing so-called medium-speed impacts,
a rigid transverse beam (10),
characterised in that the beam (10) has opposite transverse end portions (37) fixed rigidly to the front ends (2) of the two main longitudinal members (4), said end portions (37) being inserted between the impact absorbers (26) and the front ends (2) of the main longitudinal members (4).

2. Front face according to claim 1, characterised in that the beam (10) is a metal plate.

3. Front face according to claim 2, characterised in that the metal plate (10) comprises a substantially flat central zone (32), said central zone (32) extending in a substantially vertical and transverse plane.

4. Front face according to claim 3, characterised in that the central zone (32) extends over most of the transverse length of the beam (10) and over most of the vertical height of the beam (10).

5. Front face according to claim 3, characterised in that the metal plate (10) comprises a raised edge (34) directed towards the rear of the vehicle relative to the central zone, said raised edge extending over most of the periphery of the central zone (32).

6. Front face according to claim 3, characterised in that the metal plate (10) comprises a raised edge (34) directed towards the front of the vehicle relative to the central zone (32), said raised edge (34) extending over most of the periphery of the central zone (32).

7. Front face according to claim 2, characterised in that the metal plate (10) is pressed.

8. Front face according to claim 1, characterised in that the beam (10) is a metal tube.

9. Front face according to claim 8, characterised in that the tube (10) is extruded.

10. Front face according to claim 8, characterised in that the tube (10) is delimited by a transverse peripheral wall (98) in which two slots (102) are provided, the medium-speed impact absorbers (26) engaging inside the beam (10) through the slots (102).

11. Front face according to claim 1, characterised in that it comprises at least one transverse cross member (8) and at least one lock (76) for fastening the motor vehicle bonnet, the or each lock (76) being fixed rigidly to the cross member (8), the cross member being situated vertically substantially level with the front ends (2) of the main longitudinal members (4).

12. Front face according to claim 11, characterised in that the medium-speed impact absorbers (26) are inserted between the opposite transverse end portions (18) of the cross member (8) and the end portions (37) of the beam (10).

13. Front face according to claim 12, characterised in that the medium-speed impact absorbers (26) each comprise a block (28) made of a cellular material and a casing (30) into which the block (28) is inserted, the end portions (18) of the cross member (8) forming the casings (30) of the medium-speed impact absorbers (26).

14. Front face according to claim 11, characterised in that the cross member (8) is an integrally moulded component made of a plastics material.

15. Front face according to claim 11, characterised in that the cross member (8) has an opening towards the rear of the vehicle closed by the beam (10).

16. Front face according to claim 1, characterised in that the impact absorbers (26) are provided to absorb impacts with another vehicle at about 16 km/h.

17. Front face according to claim 1, characterised in that the beam (10) is provided to stabilise the main longitudinal members of the vehicle.

18. Front face according to claim 1, characterised in that the impact absorbers (26) comprise a block made of a metallic or composite cellular material.

19. Front face according to claim 4, characterised in that the metal plate (10) comprises a raised edge (34) directed towards the rear of the vehicle relative to the central zone, said raised edge extending over most of the periphery of the central zone (32).

20. Front face according to claim 4, characterised in that the metal plate (10) comprises a raised edge (34) directed towards the front of the vehicle relative to the central zone (32), said raised edge (34) extending over most of the periphery of the central zone (32).

21. Front face according to claim 9, characterised in that the tube (10) is delimited by a transverse peripheral wall (98) in which two slots (102) are provided, the medium-speed impact absorbers (26) engaging inside the beam (10) through the slots (102).
